(19) United States
(12) Patent Application Publication
(10) Pub. No.: US 2017/0160923 A1
(43) Pub. Date: Jun. 8, 2017

(54) METHOD, DEVICE AND MOBILE TERMINAL FOR CONTROLING VIRTUAL KEYS ON A TOUCH SCREEN

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Guoshuan HAN, Beijing (CN)

(21) Appl. No.: 15/240,853

(22) Filed: Aug. 18, 2016

Related U.S. Application Data
(63) Continuation of application No. PCT/CN2016/089189, filed on Jul. 7, 2016.

(30) Foreign Application Priority Data
Dec. 4, 2015 (CN) 201510885901.8

(51) Int. Cl. G06F 3/0488; G06F 3/0481

(52) U.S. Cl. CPC G06F 3/04886; G06F 3/0481

(57) ABSTRACT

The present disclosure provides a method, a device and a mobile terminal for controlling virtual keys on a touch screen. The control method includes: detecting whether a preset application is started; and shielding all virtual keys set on a mobile terminal or shielding a virtual key set on a mobile terminal and having an exit function for the preset application when it is detected that the preset application is started. The method, device and mobile terminal for controlling virtual keys on a touch screen in the present disclosure can avoid as far as possible the problem that the current running preset application exits accidentally due to user's misoperation of virtual keys.

### CROSS-REFERENCE TO RELATED APPLICATION

This application is a continuation of International PCT Patent Application No. PCT/CN2016/089189, filed Jul. 7, 2016 (attached hereto as an Appendix), and claims benefit/priority of Chinese patent application entitled “Mobile Device And Mobile Terminal For Controlling Virtual Keys On A Touch Screen”, application number 201510885901.8, filed with the State Intellectual Property Office of China on Dec. 4, 2015, which are all incorporated herein by reference in entirety.

### TECHNICAL FIELD

The present disclosure relates to the technical field of mobile terminals, and in particular, to a method, a device and a mobile terminal for controlling virtual keys on a touch screen.

### BACKGROUND

The existing mobile terminals often use touch screens (hereinafter, mobile terminals using touch screens are jointly referred to as mobile terminals). In order to facilitate users' operations and improve users' experience, generally, some functional keys are configured on the touch screen. These functional keys may be physical keys, virtual keys, or a combination of both. Take cell phone as an example, a cell phone touch screen generally has functional keys including a home key, a menu key and a return key, etc.

Based on the continuous development of touch screens, there appear a large number of applications based on touch, such as, game, video and various office tool applications. However, when a user operates one application on a touch screen, it is very likely to touch a virtual key on the touch screen due to misoperation. If the virtual key has an exit function (e.g., exit the current page and return to the previous page, or exit the application), the application will be interrupted unexpectedly due to the exit, which brings great inconvenience to the user's use. For example, the user touches a virtual key on the touch screen by mistake in the process of playing a game, while the virtual key is a return key, then it is very likely to make the game exit from the current page and over. For another example, when using one office tool, the user might also interrupt the office tool due to misoperation, and if this kind of problem occurs frequently, it will directly lead to lower office efficiency.

### SUMMARY

The present disclosure aims to solve the problem described above. One objective of the present disclosure is to provide a method, a device and a mobile terminal for controlling virtual keys on a touch screen, so as to avoid as far as possible the problem that an application exits accidentally due to user's misoperation of a virtual key on the touch screen when the application is in a running state.

According to the first aspect of the present disclosure, a method for controlling virtual keys on a touch screen is provided, which includes: detecting whether a preset application is started; and shielding all virtual keys set on a mobile terminal or shielding a virtual key set on a mobile terminal and having an exit function for the preset application, when it is detected that the preset application is started.

Optionally, before the step of shielding all virtual keys set on a mobile terminal or shielding the virtual key set on a mobile terminal and having an exit function for the preset application, the method further includes: prompting a user on a touch screen of the mobile terminal whether a shielding operation is to be performed on the virtual keys/key; the step of shielding all virtual keys set on a mobile terminal or shielding the virtual key set on a mobile terminal and having an exit function for the preset application is: shielding all the virtual keys set on the mobile terminal or shielding the virtual key set on the mobile terminal and having the exit function for the preset application in response to a user's confirmation instruction to the shielding operation.

Optionally, after the step of shielding all virtual keys set on a mobile terminal or shielding the virtual key set on a mobile terminal and having an exit function for the preset application, the method further includes: detecting whether the user is ready to exit the application; and removing the shielding of the virtual keys/key that have/has been shielded on the mobile terminal, when it is detected that the user is ready to exit the application.

Optionally, before the step of removing the shielding of the virtual keys/key that have/has been shielded on the mobile terminal, the method further includes: prompting the user on a touch screen of the mobile terminal whether to perform a removing shielding operation on the virtual keys/key that have/has been shielded on the mobile terminal; the step of removing the shielding of the virtual keys/key that have/has been shielded on the mobile terminal is: removing the shielding of the virtual keys/key that have/has been shielded on the mobile terminal in response to a user's confirmation instruction to the removing shielding operation.

Optionally, the prompt is a suspended button that pops up at an operation interface of the mobile terminal for the user to perform the shielding operation or the removing shielding operation; or, the prompt is options that pop up at an operation interface of the mobile terminal, wherein the options includes: a shielding option for the user to perform a shielding operation on the virtual keys/key and a removing shielding option for the user to perform a removing shielding operation on the virtual keys/key.

According to the second aspect, embodiments of the present application provides a device for controlling virtual keys on a touch screen, including a memory, one or more processors and one or more programs, wherein, the one or more programs when performed by the one or more processors perform the following operation:

detecting whether a preset application is started; and shielding all virtual keys set on a mobile terminal or shielding a virtual key set on a mobile terminal and having an exit function for the preset application, when it is detected that the preset application is started.

According to the third aspect, embodiments of the present disclosure further provides a computer readable storage medium, wherein the computer readable storage medium may store a computer executable instruction, which makes a device for controlling virtual keys on a touch screen perform an operation in response to its execution. The operation includes:

detecting whether a preset application is started; and shielding all virtual keys set on a mobile terminal or shielding a virtual key set on a mobile terminal and having an exit function for the preset application, when it is detected that the preset application is started.

The present disclosure provides a method, a device and a mobile terminal for controlling virtual keys on a touch screen. When a preset application is started, virtual keys/key on a mobile terminal are/is shielded so that the virtual keys/key are/is in the non-working state. In this way, even though the user performs a misoperation on keys, the misoperation would not affect the current running program, thus avoiding as far as possible the problem that the current running preset application exits accidentally due to the user's misoperation of virtual keys/key.

Reading the following description for exemplary embodiments referring to the drawings, other characters, features and advantages of the present disclosure will become clear.

It should be understood that, the above general description and the detailed description hereinafter are merely exemplary and explanatory, which are not used to limit the scope of the present disclosure.

### BRIEF DESCRIPTION OF THE DRAWINGS

The drawings, which are incorporated into the specification and constitute a part of the specification, show some embodiments of present disclosure and are used to explain the principles of the present disclosure together with the specification. In theses drawings, similar reference numbers are used to indicate similar elements. The drawings described below are some embodiments of the present disclosure, rather than being the whole embodiments. For one of ordinary skills in the art, other drawings may also be obtained according to these drawings without creative work.

FIG. 1 exemplarily shows a flowchart of a method for controlling virtual keys on a touch screen;

FIG. 2 exemplarily shows another flowchart of a method for controlling virtual keys on a touch screen;

FIG. 3 exemplarily shows yet another flowchart of a method for controlling virtual keys on a touch screen;

FIG. 4 exemplarily shows a structure diagram of a device for controlling virtual keys on a touch screen;

FIG. 5 exemplarily shows another structure diagram of a device for controlling virtual keys on a touch screen;

FIG. 6 exemplarily shows a structure schematic diagram of a mobile terminal;

FIG. 7 is a structure schematic diagram of a device for controlling virtual keys on a touch screen according to the embodiments of the present disclosure;

FIG. 8 is a structure schematic diagram of a computer program for controlling virtual keys on a touch screen according to the embodiments of the present disclosure.

### DETAILED DESCRIPTION

In order to make the objects, technical solutions and advantages of the embodiments of the present disclosure more apparent, the technical solutions in the embodiments of the present disclosure will be described clearly and completely below in conjunction with the drawings in the embodiments of the present disclosure. Apparently, the embodiments described are only a part of the embodiments of the present disclosure, rather than being the whole embodiments. All the other embodiments obtained by one of ordinary skills in the art based on the embodiments of the present disclosure without creative work pertain to the protection scope of the present disclosure. It should be noted that, without conflict, the embodiments and features in the embodiments of the present disclosure may be in any combination one another.

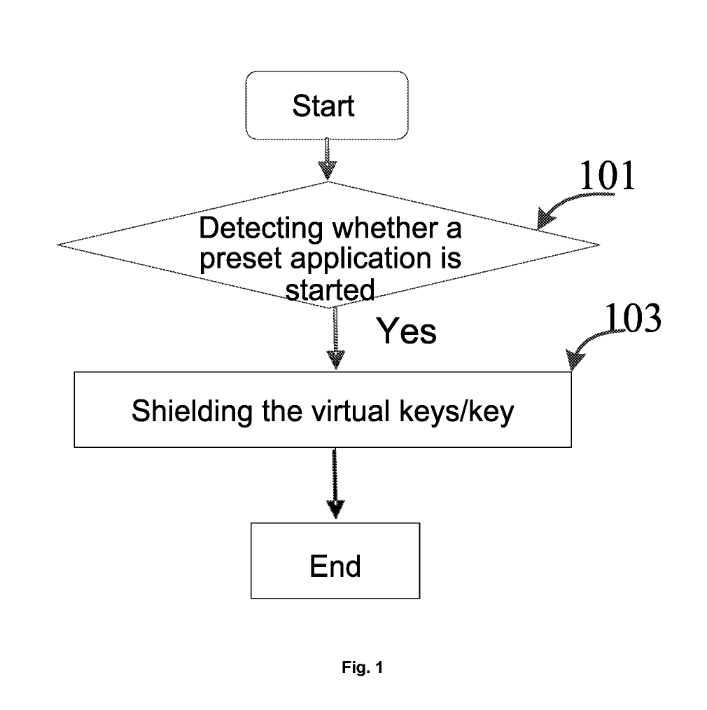

As shown in FIG. 1, a method for controlling virtual keys on a touch screen includes:

In Step 101: it is detected whether a preset application is started.

Wherein, the preset application may be a preset application like a video application, a game application or one of various office applications; means of the detecting may be: judging whether a state signal sent when the preset application is started is received, and then determining whether the preset application is started according to the state signal.

In Step 103: when it is detected that the preset application is started, all virtual keys set on a mobile terminal are shielded or a virtual key set on a mobile terminal and having an exit function for the preset application are shielded.

Wherein, shielding the virtual keys/key means making the virtual keys/key in a non-working state. In this way, even though a user touches a virtual key, the operation thereof also belongs to invalid operations.

Moreover, the mobile terminal includes, but is not limited to, a cellphone, a personal computer and a tablet computer.

The present embodiment provides a method for controlling virtual keys on a touch screen. When a preset application is started, the virtual keys/key on a mobile terminal are/is shielded so that the virtual keys/key are/is in a non-working state. In this way, even though the user performs a misoperation on keys, the misoperation would not affect the current running program, thus avoiding as far as possible the problem that the current running program exits accidentally due to the user's misoperation of the virtual keys/key.

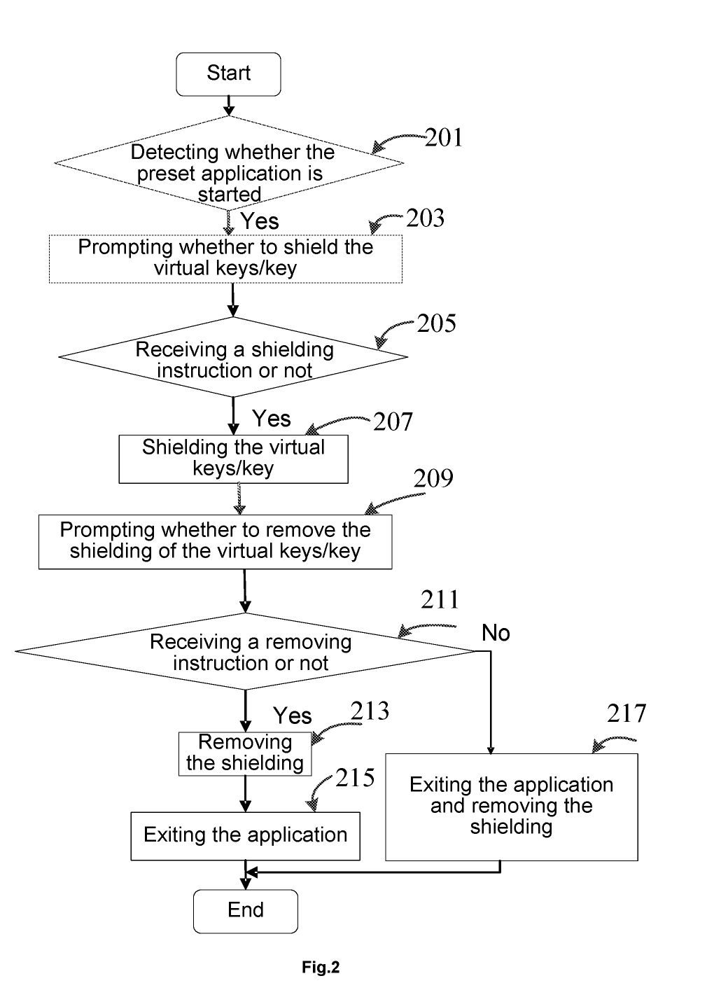

The solution shown in FIG. 2 is an optimized solution based on the solution shown in FIG. 1. As shown in FIG. 2, a method for controlling virtual keys on a touch screen includes:

In Step 201: it is detected whether a preset application is started.

Specific operations may refer to the explanations below. When it is determined that the preset application is started, Step 203 continues to be performed;

In Step 203: a user is prompted on a touch screen of a mobile terminal whether to perform a shielding operation on the virtual keys/key.

In specific operations, the prompt may be a suspended button displayed in the mobile terminal. The user clicks the suspended button to switch between a shielded state and an unshielded state. For example, the default state of the suspended button is unshielded state, and once the user clicks the suspended button, the suspended button switches from an unshielded state to a shielded state.

In Step 205: it is judged whether a user's confirmation instruction to a shielding operation (which can be understood as a shielding instruction, wherein, the confirmation instruction may be an instruction generated after clicking the suspended button) is received. If so, Step 207 is performed.

In Step 207: all the virtual keys set on the mobile terminal are shielded or the virtual key set on the mobile terminal and having an exit function for the preset application are shielded, in response to the user's confirmation instruction to the shielding operation.

In Step 209: when it is detected that the user is ready to exit the application, the user is prompted on the touch screen of the mobile terminal whether to perform a removing shielding operation on the virtual keys/key that have/has been shielded on the mobile terminal.

The prompt may be a suspended button displayed on the touch screen terminal.

In Step 211: it is judged whether the user's confirmation instruction to a removing shielding operation (which can be understood as an instruction for removing the shielding of the virtual keys/key, wherein, the confirmation instruction may be an instruction generated after clicking the suspended button) is received. If so, Step 213 is performed; if no, Step 217 is performed.

In Step 213: the shielding of the virtual keys/key that have/has been shielded on the mobile terminal is removed, in response to the user's confirmation instruction to the removing shielding operation.

Wherein, removing the shielding of the keys means making the keys in a normal working state.

In Step 215: according to the user's instruction, the current running preset application is exited and the control flow is over.

In Step 217: according to the user's instruction, when exiting (stopping) the current running preset application, the shielding of the virtual keys/key on the mobile terminal is removed and the control flow is over.

It is noted that, herein, it is not limited that exiting the preset application and removing the shielding of the virtual keys/key are executed simultaneously, so the operations between the two may exist a predetermined time difference. The Step 217 means, even the user does not operate a suspended button, when exiting from a preset application, the removing shielding operation is correspondingly triggered directly. Those skilled in the art may understand that, at the moment, though the virtual keys/key are/is shielded, according to an exit operation of the preset application itself a corresponding exit action may be conducted.

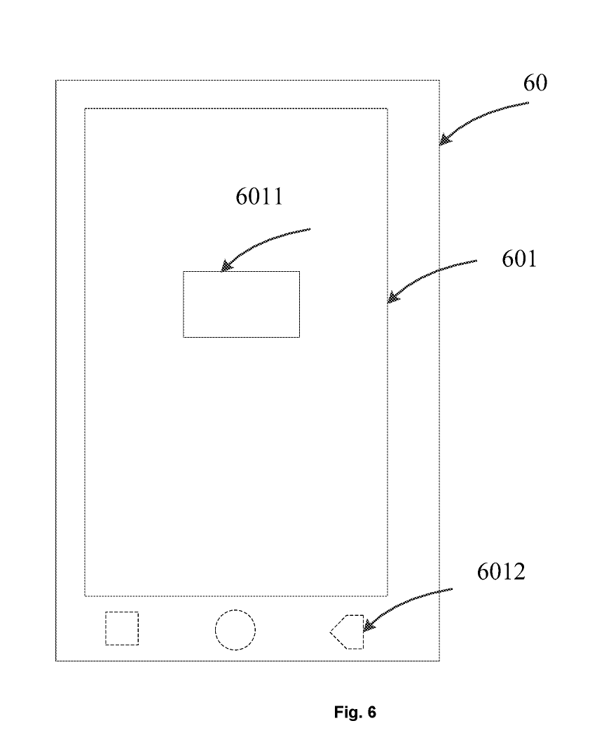

It may be understood that, in the present embodiment, when a preset application is started, a suspended button (as the suspended button 6011 shown in FIG. 6) automatically pops up in a touch screen. The suspended button may include two states, i.e., removing shielding state and shielding state, wherein, the default state may be set as removing shielding state; when the suspended button automatically pops up, a user determines whether to remove the shielding. For example, when a user prepares to watch a video or play a game and so on, he/she may choose to shield the virtual keys/key so as to avoid that the video or the game is interrupted due to touch by mistake; if the user has chosen to shield the virtual keys/key, the user is prompted to remove the shielding of the virtual keys/key when the user is ready to exit the application. If the user chooses to remove the shielding of the virtual keys, a corresponding control of removing the shielding is made; if the user does not choose to remove the shielding, the system default removes the shielding when it is judged that the application exits, so as to avoid that the keys are not removed from the shielding after the application exits. In specific operations, for the specific implementation modes of the embodiment, there are at least the following mapping modes:

Mode 1: there is a prompt whether to remove the shielding of the virtual keys/key or shield the virtual keys/key of a mobile terminal. The prompt may be a suspended button, or the expression form of the prompt may also be options that pop up at an operation interface. The options include a shielded option and an unshielded option. A user may select from the two options to indicate the shielded option or unshielded option, so that the background generates a corresponding control instruction according to the user's selections. Of course, in the technical solution of the present disclosure, the above two expression forms are merely exemplary, and other expression forms based on man-machine interaction may also be used for the prompt to which no definitive understanding should be made.

Mode 2: a suspended button or various prompt ways may appear when a preset application starts and stay all through on the touch screen until the preset application is closed. At this time, Step 209, Step 211 and Step 213 are performed before Step 215 as described in the present embodiment. Also, it may hide after the preset application starts, and appear again after the preset application exits. At this time, Step 209, Step 211 and Step 213 are performed after Step 215, i.e., the preset application is stopped to trigger the suspended button appear so as to prompt whether to remove the shielding. No limit is made here.

Mode 3: it may be set directly to shield a virtual key when a preset application is started, and to remove shielding the virtual key when the preset application is exited, according to requirements, i.e., not via the user. This mode may be as an option in order to avoid exiting from the application due to misoperation in the case that the user's option is not considered.

Mode 4: there are many ways to detect whether a user is ready to exit a preset application. For example, when the user clicks one virtual key several times in succession (such as three times) after shielding the virtual key (the virtual key has an exit function for the preset application), the mobile terminal may detect the operation of the user, and further determine that the user has a real intention of exiting the preset application according to the operation, rather than the misoperation of the virtual key by the user. Certainly, when detecting whether the user is ready to exit the preset application, times for the user to click the virtual key in succession may be preset. Considering the probability that the user touches a virtual key by mistake for successive two times is very low, the times may be at least two times. For another example, when the user clicks the suspended button before exiting the preset application, the state (shielded state/unshielded state) of the suspended button may be used to further determine whether the user is ready to exit the preset application.

The embodiment is performed by judging whether the mobile terminal starts a video application, a game application or one of various preset applications. When the preset application starts, a suspended button is started. After the user clicks the suspended button, the virtual keys/key are/is made in the non-working state. In this way, even though the virtual keys/key are/is misoperated, it would not affect the current running program (i.e., the preset application), thus avoiding exiting from the current running preset application due to misoperation of virtual keys. Further, if the user wants to close the current running program, the virtual keys/key return/returns to work after the user clicks the suspended button again (certainly, if the user fails to click the suspended button, the virtual keys/key may be forced to return to work) so as to complete the control of the virtual keys/key in the mobile terminal, which avoids exiting from the current running preset application due to misoperation meanwhile does not affect the normal use of the virtual keys/key.

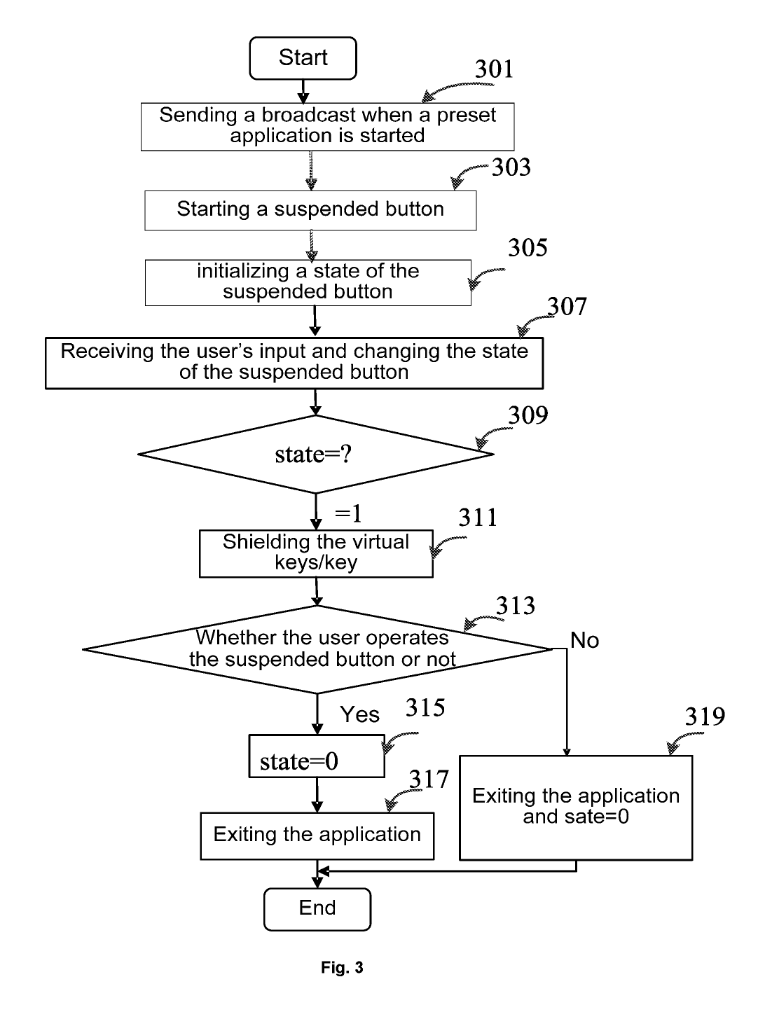

FIG. 3 is a specific embodiment of the solution shown in FIG. 2. As shown in FIG. 3, a method for controlling virtual keys on a touch screen includes:

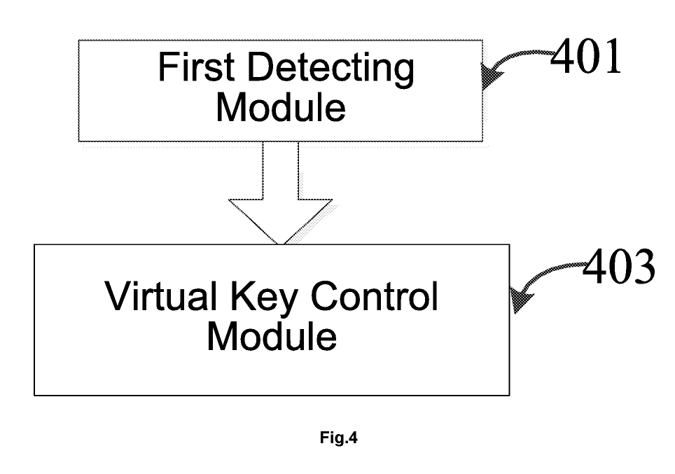

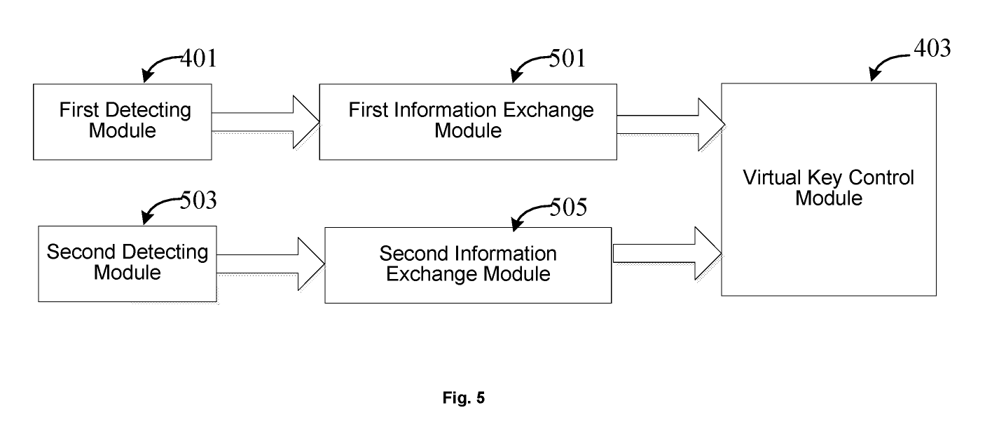

In Step 301: a broadcast is sent to a control device (specifically see the description of embodiments shown in FIG. 4 and FIG. 5) of the virtual keys/key when a preset application is started;

In Step 303: when the control device receives the broadcast, the preset application is determined open, thus a suspended button is started;

In Step 305: the control device initializes a state of the suspended button like resetting (state=0);

In Step 307: when receiving a user's input (like clicking the suspended button), the control device changes the state of the suspended button like presetting to 1 (state=1).

In Step 309: the control device judges whether the state of the suspended button indicates removing the shielding or shielding keys, i.e., state=? If it indicates shielding keys, like state=1, Step 311 is performed;

In Step 311: the control device shields the function of keys;

In Step 313: the control device judges whether the user operates the suspended button: if so, Step 315 is performed; if not, Step 319 is performed;

In Step 315: the control device resets the state of the suspended button, i.e., state=0;

In Step 317: the current running preset application (application) exits;

In Step 319: when the current running preset application exits, the control device resets the state of the suspended button.

In the present embodiment, when the preset application starts, the suspended button is started. After the user clicks the suspended button, keys are made in the non-working state. In this way, even though keys are misoperated, it would not affect the current running program, thus avoiding exiting from the current running preset application due to misoperation of keys; when the preset application is ready to be closed and after the user clicks the suspended button, the keys return to work; if the user fails to click the suspended button, the virtual keys/key may be forced to return to work so as to complete the output control of the mobile terminal, which avoids exiting from the current running preset application due to misoperation meanwhile does not affect the normal use of keys.

As shown in FIG. 4, a device for controlling virtual keys on a touch screen includes:

a first detecting module 401 configured to detect whether a preset application is started; and

a virtual key control module 403 configured to shield all virtual keys set on a mobile terminal or shield the virtual key set on a mobile terminal and having an exit function for the preset application when the preset application is started.

In the mobile terminal of the present embodiment, the device for controlling virtual keys on a touch screen performs the steps by: judging whether the preset application is started by the first detecting module 401; shielding the virtual keys/key set on the mobile terminal by the virtual key control module 403 when the preset application is started, so that keys are made in the non-working state. In this way, even though keys are misoperated, it would not affect the current running program, thus avoiding exiting from the current running preset application due to misoperation of keys.

The solution shown in FIG. 5 is an optimized mode based on the solution shown in FIG. 4. Moreover, the present embodiment is a structure of the device corresponding to the method shown in FIG. 2, The explanations of FIG. 2 may be suitable for the present embodiment. The method shown in FIG. 3 may be understood as a specific work flow by which the present embodiment operates the control device. As shown in FIG. 5, the device for controlling virtual keys on a touch screen may include:

a first detecting module 401 configured to detect whether a preset application is started;

a first information exchange module 501 configured to: prompt a user on a touch screen of the mobile terminal whether to perform a shielding operation on the virtual keys/key before the shielding operation is performed; and receive a user's confirmation instruction to the shielding operation; and

the virtual key control module 403 configured to: shield all virtual keys set on a mobile terminal or shield virtual keys set on a mobile terminal and having an exit function for the preset application in response to the user's confirmation instruction to the shielding operation.

Further preferably, in another embodiment, the device for controlling virtual keys on a touch screen may further include:

a second detecting module 503 configured to detect whether the user is ready to exit the application; and

a second information exchange module 505 configured to: prompt the user on a touch screen of the mobile terminal whether to perform a removing shielding operation on virtual keys/key that have/has been shielded on the mobile terminal; and receive a user's confirmation instruction to the removing shielding operation.

The virtual key control module 403, further configured to: remove the shielding of virtual keys/key that have/has been shielded on the mobile terminal when that the user is ready to exit the application is detected.

In the present embodiment, when the first detecting module 401 judges the preset application is started, the suspended button is started by the first information exchange module 501. The virtual keys/key are/is in the non-working state in the control of the virtual key control module 403 after the user clicks the suspended button. In this way, even though the virtual keys/key are/is misoperated, it would not affect the current running program of the mobile terminal, thus avoiding exiting from the current running program due to misoperation of keys.

when the user is ready to exit the preset application or after the user closes the preset application, the second information exchange module 505 starts the suspended button. After the user clicks the suspended button, the keys return to work in the control of the virtual key control module 403; if the user fails to click the suspended button or the suspended button does not appear (i.e., without prompt), also, the virtual keys/key may be forced to return to work so as to complete the control of virtual keys/key in the mobile terminal, which avoids exiting from the current running program due to misoperation meanwhile does not affect the normal use of keys.

Additionally, as shown in FIG. 6, the present disclosure further provides a mobile terminal 60 including a touch screen 601 and a device (not shown in figures) for controlling a virtual key 6012 in the mobile terminal. The explanation for the control device may see the description of FIG. 4 and FIG. 5. The mobile terminal has the technical effect corresponding to the control device, so it is not repeated here. FIG. 6 schematically shows a suspended button 6011. Referring to the explanation of FIG. 2, here are examples and definitive understanding should not be made.

Content described above may be implemented separately or in combination in various ways. These variant ways fall into the protection scope of the present disclosure.

Finally, it should be noted that, the above embodiments are only used for illustrating the technical solutions of the present disclosure, rather than limiting the scope thereof; although the present disclosure has been illustrated in detail by referring to the above embodiments, it should be understood by one of ordinary skills that, modifications may still be made to the technical solution recorded in each of the above embodiments, or equivalent substitutions may be made to a part of the technical characteristics thereof; moreover, these modifications or substitutions will not make the nature of corresponding technical solution depart from the spirit and scope of the technical solutions of each embodiment of the present disclosure.

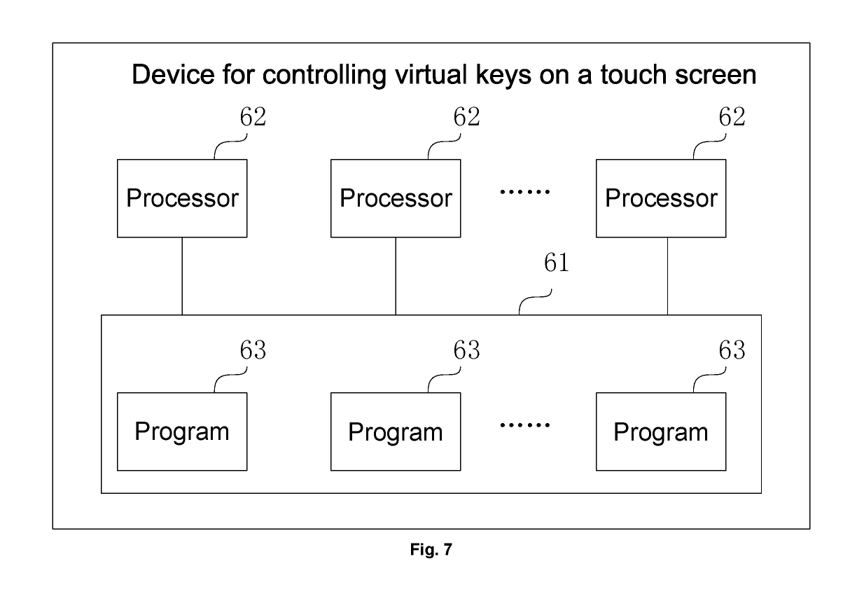

FIG. 7 is a structure schematic diagram of a mobile terminal provided by embodiments of the present disclosure. As shown in FIG. 7, the mobile terminal of embodiments of the present disclosure includes: a memory 61, one or more processors 62 and one or more programs 63.

Wherein, the one or more programs 63, when performed by the one or more processors 62, perform any one of the methods according to the above embodiments.

The mobile terminal of embodiments of the present disclosure is performed by:

detecting whether a preset application is started; when it is detected that the preset application is started, shielding all virtual keys set on a mobile terminal or shielding the virtual key set on a mobile terminal and having an exit function for the preset application. In the present disclosure, when the preset application is started, the virtual keys/key in the mobile terminal are/is shielded so that the virtual keys/key are/is in the non-working state. In this way, even though the user performs a misoperation on keys, the misoperation would not affect the current running program, thus avoiding as far as possible the problem that the currently running preset application exits accidentally due to the user's misoperation of virtual keys.

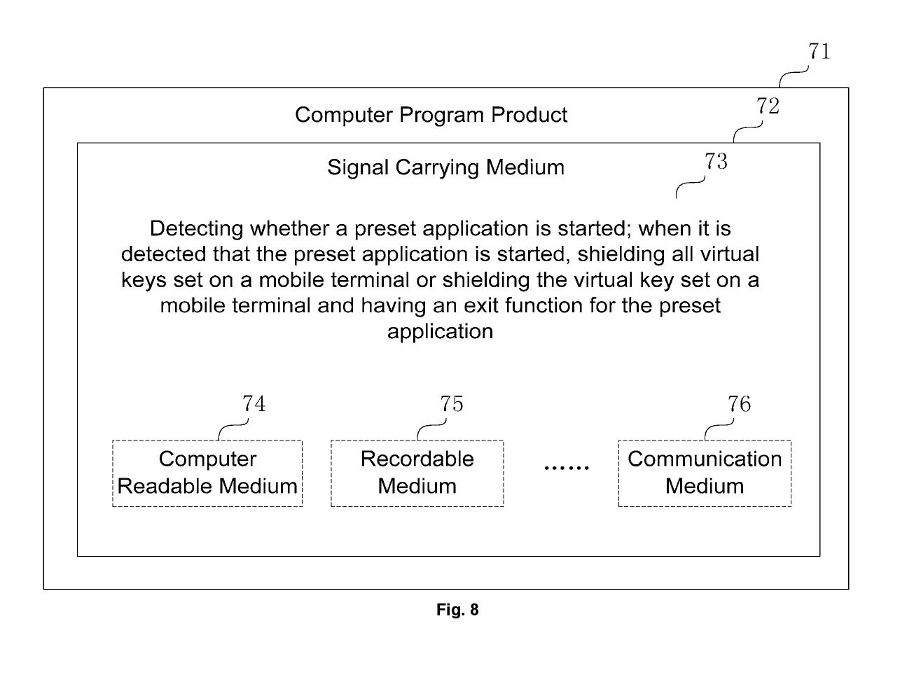

FIG. 8 is a structure schematic diagram of a computer program for controlling virtual keys on a touch screen provided by embodiments of the present disclosure. As shown in FIG. 8, the computer program product 71 for controlling virtual keys on a touch screen according to the embodiments of the present disclosure may include a signal carrying medium 72. The signal carrying medium 72 may include one or more instructions 73. For example, when the instruction 73 is performed by a processor, the processor may provide the above functions described in FIGS. 1-4. For example, The instruction 73 may be: configured to detect whether a preset application is started; and configured to shield all virtual keys set on a mobile terminal or shielding the virtual key set on a mobile terminal and having an exit function for the preset application, when it is detected that the preset application is started. Therefore, for example, referring to FIG. 1, the device for controlling virtual keys on a touch screen may perform one or more steps shown in FIG. 1 in response to the instruction 73.

In some implementation modes, the signal carrying medium 72 may include a computer readable medium 74, such as but not limited to, hard disk drive, compressed disk (CD), digital video disk (DVD), digital tape, memory and so on. In some implementation modes, the signal carrying medium 72 may include a recordable medium 75, such as but not limited to, memory, read or write (R/W) CD, R/W DVD, and so on. In some implementation modes, the signal carrying medium 72 may include a communication medium 76, such as but not limited to, digital and/or analogy communication media (such as, fiber cable, waveguide, wired communication link, wireless communication link and so on). Therefore, for example, the computer program product 71 may be transferred, by RF signal carrying medium 72, to one or more modules of the device for controlling virtual keys on a touch screen, wherein, the signal carrying medium 72 is transferred by a wireless communication medium (such as, a wireless communication medium that meets IEEE 802.11 standard).

The computer program product of embodiments of the present disclosure is performed by: detecting whether a preset application is started; when it is detected that the preset application is started, shielding all virtual keys set on a mobile terminal or shielding the virtual key set on a mobile terminal and having an exit function for the preset application. In the present disclosure, when the preset application is started, the virtual keys/key on the mobile terminal are/is shielded so that the virtual keys/key are/is in the non-working state. In this way, even though the user performs a misoperation on keys, the misoperation would not affect the current running program, thus avoiding as far as possible the problem that the current running preset application exits accidentally due to the user's misoperation of virtual keys.

By the description of the above embodiments, one skilled in the art may know clearly that the present embodiments may be achieved by virtue of software plus necessary general hardware platforms, of course, it may also be achieved by hardware. Based on such understanding, the technical solutions described above in essence or the part contributing to the prior art may be present in the form of a software product. The computer software product may be stored in a computer readable storage medium, such as read-only memory (ROM), random access memory (RAM), magnetic disk and CD, etc., containing some instructions to direct a computer equipment (may be a personal computer, a server, or network equipment and so on) to perform the method mentioned in various embodiments or certain parts of each embodiment of the present disclosure. The aforementioned description may be implemented individually or combined in various ways. These variant ways fall into the protection scope of the present disclosure.

The above are only specific embodiments of the present disclosure and the scope of the present disclosure is not limited hereto. Any equivalent modifications or substitutions easily conceived by one of ordinary skills in the art within the technology scope of the present disclosure shall fall into the scope of the present disclosure. Therefore, the scope of the present disclosure shall be defined by the appended claims.

1. A method for controlling virtual keys on a touch screen, comprising:
detecting whether a preset application is started; and
shielding all virtual keys set on a mobile terminal or shielding a virtual key set on a mobile terminal and having an exit function for the preset application, when it is detected that the preset application is started.

2. The method for controlling virtual keys on a touch screen according to claim 1, wherein,
before the step of shielding all virtual keys set on a mobile terminal or shielding the virtual key set on a mobile terminal and having an exit function for the preset application, the method further comprises: prompting a user on a touch screen of the mobile terminal whether a shielding operation is to be performed on the virtual keys/key;
the step of shielding all virtual keys set on a mobile terminal or shielding the virtual key set on a mobile terminal and having an exit function for the preset application is:
shielding all the virtual keys set on the mobile terminal or shielding the virtual key set on the mobile terminal and having the exit function for the preset application in response to a user's confirmation instruction to the shielding operation.

3. The method for controlling virtual keys on a touch screen according to claim 1, wherein, after the step of shielding all virtual keys set on a mobile terminal or shielding the virtual key set on a mobile terminal and having an exit function for the preset application, the method further comprises:
detecting whether the user is ready to exit the application; and
removing the shielding of the virtual keys/key that have/has been shielded on the mobile terminal, when it is detected that the user is ready to exit the application.

4. The method for controlling virtual keys on a touch screen according to claim 3, wherein,
before the step of removing the shielding of the virtual keys/key that have/has been shielded on the mobile terminal, the method further comprises:
prompting the user on the touch screen of the mobile terminal whether to perform a removing shielding operation on the virtual keys/key that have/has been shielded on the mobile terminal;
the step of removing the shielding of the virtual keys/key that have/has been shielded on the mobile terminal is:
removing the shielding of the virtual keys/key that have/has been shielded on the mobile terminal in response to a user's confirmation instruction to the removing shielding operation.

5. The method for controlling virtual keys on a touch screen according to claim 2, wherein,
the prompt is a suspended button that pops up at an operation interface of the mobile terminal for the user to perform the shielding operation or the removing shielding operation; or
the prompt is options that pop up at an operation interface of the mobile terminal, wherein the options comprises: a shielding option for the user to perform a shielding operation on the virtual keys/key and a removing shielding option for the user to perform a removing shielding operation on the virtual keys/key.

6. A device for controlling virtual keys on a touch screen, wherein, the device comprises a memory, one or more processors and one or more programs, wherein, the one or more programs when performed by the one or more processors perform the following operation:
detecting whether a preset application is started; and
shielding all virtual keys set on a mobile terminal or shield a virtual key set on a mobile terminal and having an exit function for the preset application, when it is detected that the preset application is started.

7. A computer readable storage medium, wherein the computer readable storage medium stores a computer executable instruction, which makes the device for controlling virtual keys on a touch screen perform an operation in response to its execution. The operation comprises:
detecting whether a preset application is started; and shielding all the virtual keys set on the mobile terminal or shield the virtual key set on the mobile terminal and having the exit function for the preset application, when it is detected that the preset application is started.

8. The method for controlling virtual keys on a touch screen according to claim 4, wherein,
the prompt is a suspended button that pops up at an operation interface of the mobile terminal for the user to perform the shielding operation or the removing shielding operation; or
the prompt is options that pop up at an operation interface of the mobile terminal, wherein the options comprises: a shielding option for the user to perform a shielding operation on the virtual keys/key and a removing shielding option for the user to perform a removing shielding operation on the virtual keys/key.

9. The method for controlling virtual keys on a touch screen according to claim 2, wherein, after the step of shielding all virtual keys set on a mobile terminal or shielding the virtual key set on a mobile terminal and having an exit function for the preset application, the method further comprises:
detecting whether the user is ready to exit the application; and
removing the shielding of the virtual keys/key that have/has been shielded on the mobile terminal, when it is detected that the user is ready to exit the application.

10. The method for controlling virtual keys on a touch screen according to claim 9, wherein,
before the step of removing the shielding of the virtual keys/key that have/has been shielded on the mobile terminal, the method further comprises:
prompting the user on the touch screen of the mobile terminal whether to perform a removing shielding operation on the virtual keys/key that have/has been shielded on the mobile terminal;
the step of removing the shielding of the virtual keys/key that have/has been shielded on the mobile terminal is:
removing the shielding of the virtual keys/key that have/has been shielded on the mobile terminal in response to a user's confirmation instruction to the removing shielding operation.

11. The method for controlling virtual keys on a touch screen according to claim 10, wherein,
the prompt is a suspended button that pops up at an operation interface of the mobile terminal for the user to perform the shielding operation or the removing shielding operation; or
the prompt is options that pop up at an operation interface of the mobile terminal, wherein the options comprises: a shielding option for the user to perform a shielding operation on the virtual keys/key and a removing shielding option for the user to perform a removing shielding operation on the virtual keys/key.
